(19) United States
(12) Patent Application Publication
(10) Pub. No.: US 2008/0273256 A1
(43) Pub. Date: Nov. 6, 2008

(54) MICROSCOPE OBJECTIVE AND ADJUSTING METHOD THEREFOR

(76) Inventors: Hiroyuki Maruko, Ina (JP); Hideto Yamashita, Kamiina (JP)

Correspondence Address: ARNOLD INTERNATIONAL, P.O. BOX 129, GREAT FALLS, VA, 22066-0129, US

(21) Appl. No.: 12/109,994

(22) Filed: Apr. 25, 2008

(30) Foreign Application Priority Data
May 2, 2007 (JP) 2007-121879

(51) Int. Cl. G02B 7/04

(52) U.S. Cl. 359/823

(57) ABSTRACT

A microscope objective includes: a plurality of optics sharing an optical axis, a plurality of optics frames holding at least one of the plurality of optics, an objective lens barrel with a plurality of holes penetrating the side wall of the objective lens barrel in which the plurality of optics frames are sequentially stacked; and a metal shim arranged between surfaces which are stacked with each optics frames. With the configuration, the metal shim is inserted from the holes penetrating the objective lens barrel.

### CROSS REFERENCE TO RELATED APPLICATION

This application claims benefit of Japanese Application No. 2007-121879, filed May 2, 2007, the contents of which are incorporated by this reference.

### BACKGROUND OF THE INVENTION

1. Field of the Invention

The present invention relates to a microscope objective, and more specifically to a configuration of the optics frame for fixing the optics in the microscope objective.

2. Description of the Related Art

Microscope objectives comprise ten or more lenses, and deliver their designed performance by arranging the lenses at the appropriate spacing. Therefore, each lens is fixed to the optics frame (internal frame), space-adjusted so that each lens can be appropriate arranged, and stacked in the objective lens barrel (outer frame).

To fix the optics frames (internal frame) in the objective lens barrel, the optics frames are pressed forward and backward in the barrel. However, if the pressure is transmitted to the optics in the optics frame, there occurs the problem of the distortion of the optics.

There are basically two types of distortion of optics, that is, internal distortion and surface distortion. The internal distortion refers to the distortion of internal optical characteristics. The glass material of optics is produced not to have optical anisotropy, but becomes optically anisotropic when stress is applied to it. This phenomenon is a serious problem especially in a polarization observation.

The surface distortion refers to deformation of the surface of the optics due to applied pressure. The surface accuracy of the optics cause a problem relating to image quality develops.

A primary factor of transmitting stress to optics is the inaccuracy of the shape of an optics frame. Although an optics frame is precisely produced, there occurs some bump on its surface or distortion in the shape. This inaccuracy of the optics frame causes the stress when the optics frames are pressed in the objective lens barrel.

Furthermore, in the adjusting of objectives, the optics frames can be used, because of the property of the optics frame determining the position of the optics. That is, the position of the optics can be correctly adjusted to attain designed performance when an objective assembles. For example, by interposing a washer between the optics frames, the space between lenses can be adjusted. This technology is disclosed by the Japanese Published Patent Application No. 2006-184485.

### SUMMARY OF THE INVENTION

According to an aspect of the present invention, a microscope objective includes: a plurality of optics sharing an optical axis, a plurality of optics frames holding at least one of the plurality of optics, an objective lens barrel with a plurality of holes penetrating the side wall of the objective lens barrel in which the plurality of optics frames are sequentially stacked; and a metal shim arranged between surfaces which are stacked with each optics frames. With the configuration, the metal shim is inserted from the holes penetrating the objective lens barrel.

According to another aspect of the present invention, a microscope objective having a plurality of optics sharing an optical axis, a plurality of optics frames holding at least one of the plurality of optics, and an objective lens barrel in which the plurality of optics frames are sequentially stacked includes: a washer with a projected metal shim in the direction of the radius; and a groove made parallel to an optical axis in the inside wall of the objective lens barrel. With the configuration, the washer is arranged so that only the metal shim is interposed between the optics frames, and the metal shim is engaged in the groove and aligned in the direction of the optical axis.

According to a further aspect of the present invention, a method for adjusting a microscope objective having a plurality of optics sharing an optical axis, a plurality of optics frames holding at least one of the plurality of optics, and an objective lens barrel in which the plurality of optics frames are sequentially stacked includes the steps of: inserting a metal shim from a point external to the objective lens barrel through a plurality of holes made in the objective lens barrel, and selectively switching the thickness of the metal shim.

### BRIEF DESCRIPTION OF THE DRAWINGS

FIG. 1A is an explanatory view of the prior art;

FIG. 1B is an explanatory view of the prior art;

FIG. 1C is an explanatory view of the prior art;

FIG. 2A shows an example of a shim and a washer used in an embodiment of the present invention;

FIG. 2B shows an example of a shim and a washer used in an embodiment of the present invention;

FIG. 2C shows a mode of a shim and a washer used in an embodiment of the present invention;

FIG. 3A is a sectional view of the objective in the direction of the cross section of the optical axis according to an embodiment;

FIG. 3B is a sectional view of the objective in the direction of the cross section of the optical axis according to an embodiment;

FIG. 3C is a sectional view of the objective in the direction of the cross section of the optical axis according to an embodiment;

FIG. 4 shows a general view of inserting the shim according to an embodiment of the present invention from the outside of the objective lens barrel;

FIG. 5A shows an example of the objective lens barrel according to an embodiment of the present invention;

FIG. 5B shows an example of the objective lens barrel according to an embodiment of the present invention;

FIG. 5C shows an example of the objective lens barrel according to an embodiment of the present invention;

FIG. 6 is a sectional view of the objective in the direction of the optical axis according to an embodiment of the present invention; and

FIG. 7 is a sectional view of the objective in the direction of the optical axis according to an embodiment of the present invention.

### DESCRIPTION OF THE PREFERRED EMBODIMENTS

The embodiments of the present invention are described below with reference to the attached drawings.

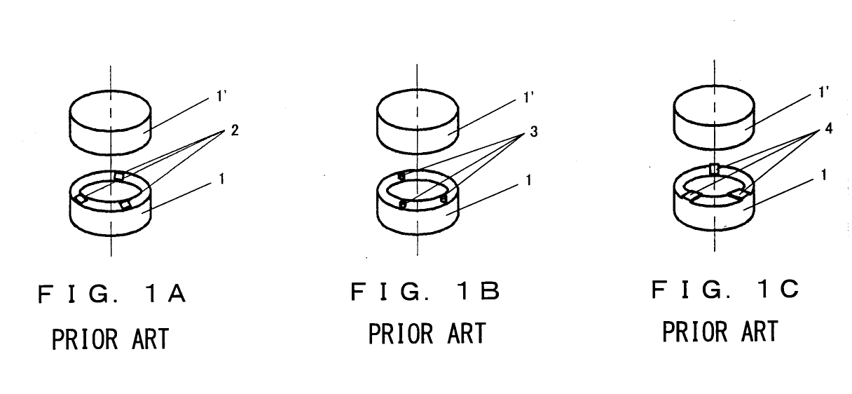

First, the adjustment of the spacing of optics frames in the conventional method with reference to FIGS. 1A through 1C. FIG. 1A shows the adjustment of optics frame spacing. FIG. 1A shows a system of interposing a shim (foil, metal shim) 2 between an optics frame 1 and an optics frame 1′. FIG. 1B shows a system of interposing a bridge 3 between the optics frame 1 and the optics frame 1′. FIG. 1C shows the system of decreasing the contact points by providing a step 4 for at least one of the optics frame 1 and the optics frame 1′. These methods can be effectively used for a large objective of, for example, a photolithography of the optics frame 1 and the optics frame 1′, but cannot be used for a small microscope objective. For example, in the configuration of arranging the bridge shown in FIG. 1B, the bridge is too small (about 1 mm in radius) to be arranged in an appropriate place.

### Embodiment 1

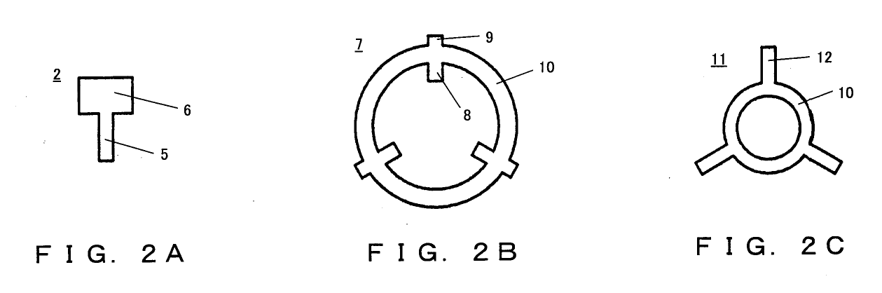

FIG. 2A shows an example of the shape of the shim used in the first mode for embodying the invention. Since the optics frame of a microscope is very small, different sizes are defined for an insertion unit 5 to be interposed between the optics frames and a knob unit 6, thereby acquiring both convenience and effect. In the example shown in FIG. 2A, a T-shaped unit is illustrated. In this case, with the size of the optics frame of the microscope taken into account, it is desired that the width of the insertion unit 5 is about 3 mm, and the knob unit 6 is appropriately configured to be easily caught by tweezers or fingers. It is also desired that the thickness of the shim 2 can be varied in adjusting the spacing of the optics frame 1.

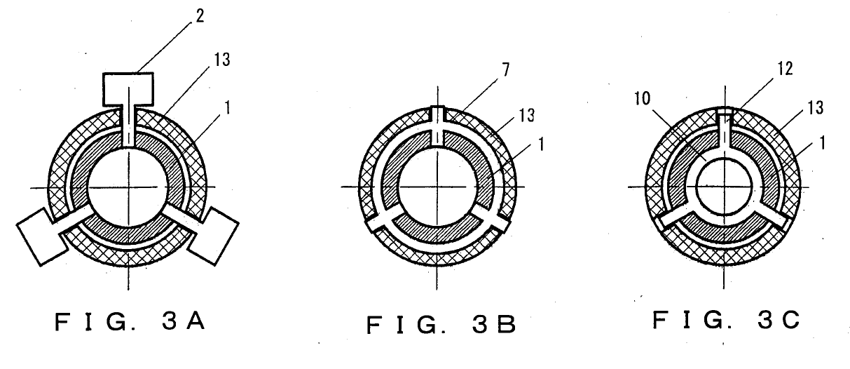

FIG. 3A is a schematic diagram of the section of the objective as interposed between the optics frame 1 in the present invention. In the example shown in FIG. 3A, a groove or a hole is made in an objective lens barrel 13 of the diagonal grid portion to insert the shim 2 between the optics frames 1 from the outside of the objective. That is, although the optics frame 1 is small, the shim 2 can be easily arranged in an appropriate position. It is desired that the number of the shims 2 arranged in the direction of the radius of the optics frame 1 is three. With the configuration, the optics frame can be supported at three points by the metal shims, and it is geometrically stable.

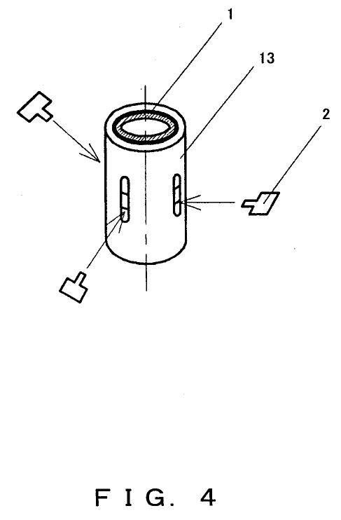

FIG. 4 is a general view of inserting the shim 2 from the outside of the objective lens barrel 13. As shown in FIG. 4, the optics frame 1 is stacked in the objective lens barrel 13, and the lamination can be viewed from the groove made in the side of the objective lens barrel 13. Then, the shim 2 can be inserted between the optics frame 1 through the groove. That is, the spacing can be adjusted without rearranging the optics frame 1. Since the groove is made in the direction of the optical axis, the shim 2 can be inserted along the groove, and the shim 2 can be correctly arranged.

In the microscope objective according to the embodiment, a metal shim can be externally inserted and removed, the spacing of the optics frames can be easily adjusted, and the distortion of the optics frames is not transmitted to optics.

In the microscope objective according to the present invention, the arrangement of the optics can be adjusted by selectively switching the thickness of the metal shim. In this method, a lens can be correctly adjusted.

### Embodiment 2

FIG. 2B shows an example of the shape of a washer A for use in the second mode for embodying the invention. The shim used in the first embodiment is made large to be easily treated, but it is not large enough to be easily treated. Thus, three units of the shims 2 according to the embodiment 1 are combined as a washer A7 as shown in FIG. 2B.

It is considered that the washer A7 can be a ring unit 10 by extending the knob unit 6 of the shim 2. That is, it includes an insertion unit 8 as with the shim 2. A guide unit 9 is provided as a projection not to allow the washer A7 to rotate between the optics frames. The angle of the washer A7 is set by engaging the guide unit 9 in the groove or the hole made in the objective lens barrel.

FIG. 3C is a schematic diagram of the section of the washer A7 interposed between the optics frames 1. As shown in FIG. 3C, the washer A7 is arranged between an objective lens barrel 13 and the optics frame 1, and only the insertion unit 8 is interposed between the insertion units 8. At this time, the washer A7 is ring-shaped, but the space between the optics frames 1 is supported at three points. With the configuration, since the optics frame is supported at three points by the metal shim, it is geometrically stable.

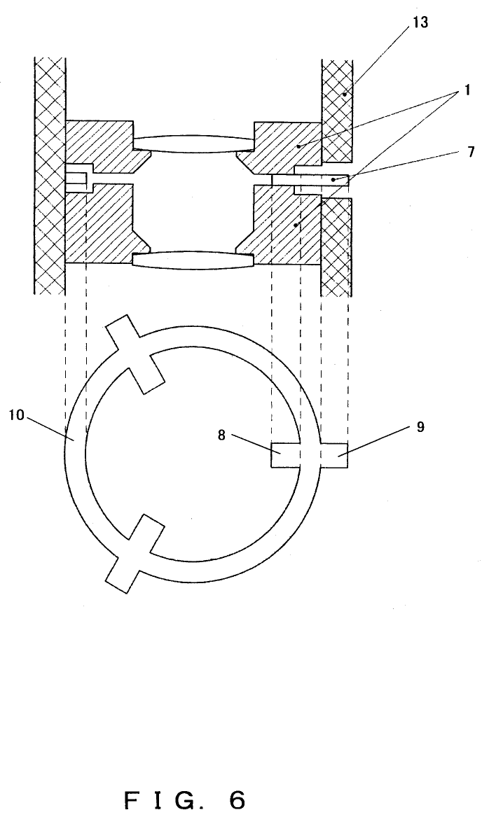

The above mentioned facts are clearly indicated with reference to a sectional view. FIG. 6 shows the washer A7 arranged between the objective lens barrel 13 and the optics frame 1, and only the insertion unit 8 is interposed between the optics frames 1 as shown in the sectional view. The lamination surface is provided with a step etc. to keep appropriate space not to interpose the ring unit 10 of the washer A7. On the other hand, the insertion unit 8 is configured to be interposed between the lamination surfaces of the optics frame 1, and the guide unit 9 is engaged in a hole or a groove provided for the objective lens barrel 13 to determine the position in the direction of the perimeter.

According to the above mentioned mode for embodying the invention, the stress is not transmitted to optics when the optics frame is pressed and fixed as in the embodiment 1.

### Embodiment 3

FIG. 2C shows an example of the shape of a washer B used according to the third mode for embodying the invention. The shape can be assumed to be three shims connected to each other in the embodiment 1. That is, the washer B11 can be the ring unit 10 by extending the knob unit 6 of the shim 2.

In the mode for embodying the invention, there is no guide unit that is provided in the embodiment 2. In this embodiment, a guide insertion unit 12 that can function as a guide unit and insertion unit is provided. The guide insertion unit 12 can have the functions on the two units by having the length of penetrating the thickness of the optics frame 1 and reaching the objective lens barrel 13.

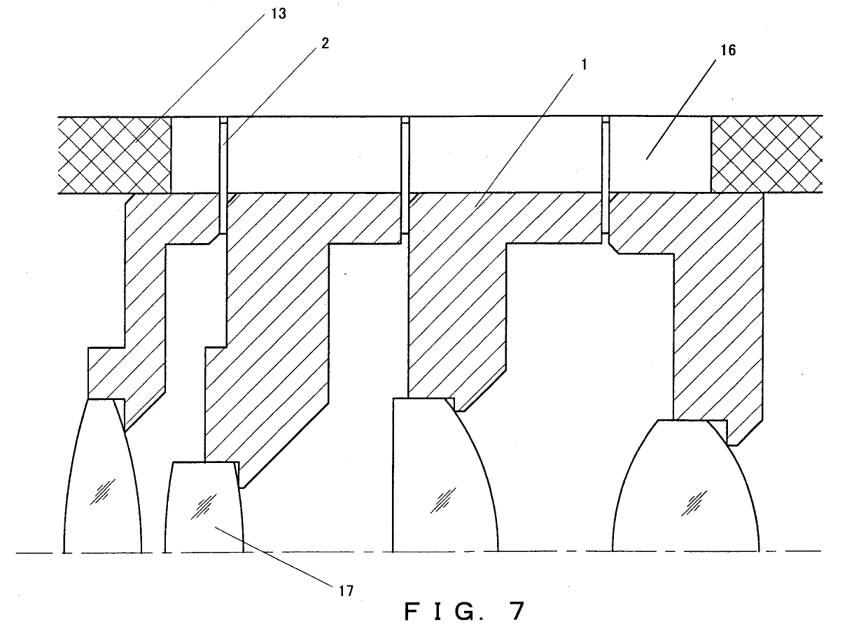

FIG. 3-3 is a schematic diagram of the section of the washer B11 interposed between the optics frames 1. As shown in this figure, the washer B11 is arranged inside the optics frame 1, and the guide insertion unit 12 is arranged to reach the objective lens barrel 13 through the optics frames 1. At this time, there is space around the optics frame 1 and the supported by the optics frame 1 (refer to FIG. 7), and the ring unit 10 can be arranged without interfering with the ring unit 10. With this configuration, the guide insertion unit 12 can set the angle of the washer B11, and support the spacing between the optics frames 1 at the three points. That is, according to this mode for embodying the invention, the stress is not transmitted to optics when the optics frame is pressed and fixed as in the embodiment 1.

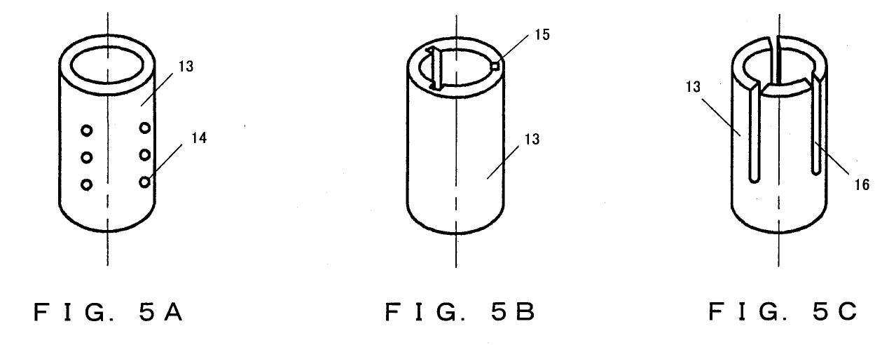

Described below are common facts among the above mentioned embodiments. FIG. 5 shows some examples of the modes of the objective lens barrel 13 according to the embodiments of the present invention.

FIG. 5A shows an example of providing holes penetrating the objective lens barrel 13 in the side of the objective lens barrel. It is desired that the holes are arranged in the direction along the optical axis at the positions splitting the perimeter of the objective lens barrel 13 three ways. The interval of the holes 14 is determined to match the interval of the optics frames 1.

The objective lens barrel 13 shown in FIG. 5A can match the shim as in the embodiment 1, and the types of washers as in the embodiments 2 and 3 can be realized. However, in the case of the objective lens barrel 13 of a washer type, an elastic material is used and inserted into the objective lens barrel 13 with some distortion.

FIG. 5B shows a groove 15 in the side of the objective lens barrel 13. It is desired that the groove 15 is made along the optical axis in the positions splitting the perimeter of the objective lens barrel 13 three ways. It is considered that the groove 15 reaches the end of the aperture of the objective lens barrel 13, but it is also acceptable that the groove 15 does not reach it. However, when the groove 15 does not reach the end of the aperture, an elastic material is used for a washer.

The objective lens barrel 13 shown in FIG. 5B cannot match the shim as described according to the embodiment 1, but can be preferably applied to a washer type described according to the embodiments 2 and 3.

FIG. 5C shows an example of making a groove 16 penetrating the objective lens barrel in the side of the objective lens barrel 13. It is considered that the groove 16 reaches the end of the aperture of the objective lens barrel 13, but it is also acceptable that the groove 16 does not reach it. FIG. 4 shows the case in which the groove does not reach the end of the aperture.

The objective lens barrel 13 shown in FIG. 5C can match the shim as described according to the embodiment 1, but can be preferably applied to a washer type described according to the embodiments 2 and 3. However, when the groove 16 does not reach the end of the aperture, an elastic material is used for a washer, and the insertion is performed into the objective lens barrel 13 with distortion.

FIG. 7 is a schematic diagram showing the section of the microscope objective as an embodiment of the present invention. In the embodiment shown in FIG. 7, the groove 16 is made in the objective lens barrel 13 and the shim 2 is inserted between the optics frames 1. FIG. 7 is a sectional view showing the surface including the optical axis and the groove 16 of the microscope objective.

As shown in FIG. 7, lenses 17 are supported by the optics frames 1 and arranged in the objective lens barrel 13. At this time, the optics frames are stacked on each other and stored in the objective lens barrel 13, thereby determining the spacing of the lenses 17. The shim 2 inserted through the groove 16 is interposed between the lamination surfaces of the optics frame 1.

Since the spacing and the tilt of the optics frame 1 can be adjusted by adjusting the thickness of the shim 2, the spacing and the tilt of the lens can be adjusted. At this time, the configuration of external inserting and removing the shim 2 into and from the objective lens barrel 13 effectively functions.

The shim 2 shown in FIG. 7 is obtained by removing the portion (knob unit 6) extending off the objective lens barrel 13. When all adjustments are completed, the portion extending off the objective lens barrel 13 is useless. Therefore, it is desired to finally remove the portion extending off the objective lens barrel 13.

As described above, according to the embodiments of the present invention, not only the operation of reducing the stress on the optics in the microscope objective can be realized, but also the lens can be adjusted, thereby providing a microscope objective having guaranteed optical quality.

What is claimed is:

1. A microscope objective comprising:
a plurality of optics sharing an optical axis,
a plurality of optics frames holding at least one of the plurality of optics,
an objective lens barrel with a plurality of holes penetrating the side wall of the objective lens barrel in which the plurality of optics frames are sequentially stacked; and
a metal shim arranged between surfaces which are stacked with each optics frames, wherein
the metal shim is inserted from the holes penetrating the objective lens barrel.

2. The objective according to claim 1, wherein
the plurality of holes are arranged in a direction along an optical axis at positions splitting a perimeter of the objective lens barrel three ways.

3. The objective according to claim 1, wherein
the plurality of holes are a long groove in a direction of an optical axis at positions splitting a perimeter of the objective lens barrel three ways.

4. The objective according to claim 1, wherein
the metal shim has a narrow portion and a wide portion, and the narrow portion is inserted into each of the plurality of holes.

5. A microscope objective having a plurality of optics sharing an optical axis, a plurality of optics frames holding at least one of the plurality of optics, and an objective lens barrel in which the plurality of optics frames are sequentially stacked, comprising:
a washer with a projected metal shim in a direction of a radius; and
a groove made parallel to an optical axis in the inside wall of the objective lens barrel, wherein:
the washer interposes only the metal shim between the optics frames; and
the metal shim is engaged in the groove and aligned in a direction of an optical axis.

6. The objective according to claim 5, wherein
the washer with the metal shim has the metal shim outside a ring unit; and
the length of the metal shim is substantially equal to a sum of a width of a lamination surface of the optics frame and a depth of the groove of the objective lens barrel.

7. The objective according to claim 5, wherein:
the washer with the metal shim has the metal shim arranged inside of a ring unit, and has a guide projection to be engaged in the groove of the objective lens barrel outside the ring unit.

8. A method for adjusting a microscope objective having a plurality of optics sharing an optical axis, a plurality of optics frames holding at least one of the plurality of optics, and an objective lens barrel in which the plurality of optics frames are sequentially stacked comprising the steps of:
inserting a metal shim from a point external to the objective lens barrel through a plurality of holes made in the objective lens barrel; and
selectively switching a thickness of the metal shim.

9. The method for adjusting the microscope objective according to claim 8, wherein
the plurality of holes are arranged in a direction along an optical axis at positions splitting a perimeter of the objective lens barrel three ways.

10. The method for adjusting the microscope objective according to claim 8, wherein
the plurality of holes are a long groove in a direction of an optical axis at positions splitting a perimeter of the objective lens barrel three ways.

11. The method for adjusting the microscope objective according to claim 8, wherein
the metal shim has a narrow portion and a wide portion, and the narrow portion is inserted into each of the plurality of holes.
